(19) United States
(12) Patent Application Publication
(10) Pub. No.: US 2011/0232314 A1
(43) Pub. Date: Sep. 29, 2011

(54) REFRIGERATION DEVICE

(75) Inventor: Francisco Javier Florez Mancho, Villava (Navarra) (ES)

(73) Assignee: BSH BOSCH UND SIEMENS HAUSGERÄTE GMBH, Munich (DE)

(21) Appl. No.: 13/131,031

(22) PCT Filed: Nov. 24, 2009
(86) PCT No.: PCT/EP2009/065750

§ 371 Date: May 25, 2011

(30) Foreign Application Priority Data
Dec. 18, 2008 (DE) 10 2008 054 936.3

(51) Int. Cl. F25D 21/14; B23P 15/26

(52) U.S. Cl. 62/291; 29/890.035

(57) ABSTRACT

A refrigeration device, in particular a domestic refrigeration device, includes a compressor that is connected in a refrigeration circuit and a condensation collection container that collects condensation formed during the operation of the refrigeration device. The condensation collection container has a base resting on an upper face of the compressor and having a side wall which projects towards the compressor and embraces a periphery of the compressor in the manner of a frame.

The invention relates to a refrigeration appliance, in particular a household refrigeration appliance, as claimed in the preamble of claim 1, a condensation collection container as claimed in claim 14 and a method for assembling a refrigeration appliance as claimed in claim 15.

Refrigeration appliances have a refrigeration chamber enclosed by a thermally insulated housing and cooled by means of an evaporator of a refrigerant circuit. Condensation is deposited on the respective cooling surfaces of the refrigeration compartment, collects in the interior of the housing and is conducted out of the housing by way of a condensation line.

In addition to the evaporator a generic refrigeration appliance also features a compressor connected in the refrigeration circuit with an assigned condensation collection container. This container collects condensation formed during operation of the refrigeration appliance and its container base rests on an upper face of the compressor. This allows the waste heat from the compressor to be used to evaporate the condensation collected therein.

For effective evaporation of the condensation collected in the condensation collection container, the contact surface between the condensation collection container and the compressor must be as large as possible. However the size of the contact surface is limited for assembly reasons in the generic refrigeration appliance, as the condensation collection container is pushed onto the compressor in a horizontal assembly direction. The base of the condensation collection container, which is tailored to the shape of the compressor, is therefore configured to be open at the side in the assembly direction.

The object of the invention is to provide a refrigeration appliance or condensation collection container, wherein there is more efficient evaporation of collected condensation.

The object is achieved by the features of claim 1, claim 14 or claim 15. Advantageous developments of the invention are disclosed in the subclaims.

According to the characterizing portion of claim 1 the container base of the condensation collection container is configured with a side wall that projects down and runs around it in the manner of a frame. The side wall therefore delimits the periphery of the compressor. This provides a container with a container base embodied in the manner of a hood, which can cover the upper region of the compressor, running round it in a peripheral direction. Together with the side wall the container base forms a hollow space that is closed in a lateral direction but open at the base, in which most of the waste heat from the compressor can be held.

In a technically simple embodiment the condensation collection container can be a collecting tray, which can be produced at low cost as a plastic part using a plastic injection molding procedure.

To assist further with condensation evaporation the container base together with its side wall can follow the contour of the upper compressor region with a form fit. This provides full surface contact between the container and the compressor, thereby increasing the transfer of heat correspondingly.

A container tailored with such a form fit therefore forms a negative shape in relation to the upper compressor region. The container is then disposed on the compressor without movement air in a horizontal direction. The container is therefore fixed on the compressor with a form fit in the horizontal plane and can only be detached from the compressor in the vertical direction. Therefore only securing measures are required, which can prevent inadvertent detachment of the container upward in the vertical direction. Fastening elements to hold the container on the compressor can therefore be designed with less stringent requirements.

The inventive condensation collection container is also more resistant to lateral forces, as may occur for example during compressor assembly or during customer service visits when disassembling the compressor. Such lateral forces can be absorbed by the side wall around the condensation collection container due to the inventive container shape, not just by the fastening element of the container.

The inventively configured condensation collection container can be positioned on the compressor in a vertical assembly direction. For fast assembly the container can be made to engage with the compressor without tools. The container preferably has a fastening element on its base, for example a latching element, that can be made to engage with a corresponding holding part of the compressor without tools.

The holding part can be disposed on the upper face of the compressor, in particular at least in proximity to a top point of the upper face of the compressor.

When engaged with the holding part the fastening element can hold the condensation collection container in a pretensioned manner on the upper face of the compressor, preferably on the top point of the upper face of the compressor.

It is preferable for the abovementioned fastening element to be configured directly within the container base. With this in mind a fastening well can preferably be configured for the fastening element in the base of the condensation collection container.

The fastening well can be configured roughly in a box shape with one side open toward the compressor for greater dimensional stability. The holding part of the compressor can project into the fastening well, being enclosed by the side walls of the well in the manner of a frame. The fastening element can preferably be configured within the fastening well with dimensional stability on a top wall of the well, which is at a predefined distance from the compressor.

The inventive shape means that the condensation collection container can have a collection channel running all the way round it, enclosing the sides of the compressor and being closed in the manner of a frame. The water collection surface directly on the condenser is correspondingly enlarged. The collection channel can preferably enclose the sides of the compressor with a height difference vertically below the top point of the compressor, with the result that the condensation is disposed around the compressor in a manner that is favorable for evaporation.

In one technically simple embodiment the collection channel can be delimited on the inside by the side wall of the container base and on the outside by a container outer wall. The inner side wall can be connected to the container outer wall by way of an edge web that forms the channel base.

During customer service visits, in other words during disassembly, simple tool access to the fastening element is advantageous. To this end access openings can be provided in the side or top walls of the fastening well. If the top wall of the well supports the fastening element, the access opening can preferably be configured in the top wall.

An exemplary embodiment of the invention is described below with reference to the accompanying figures, in which:

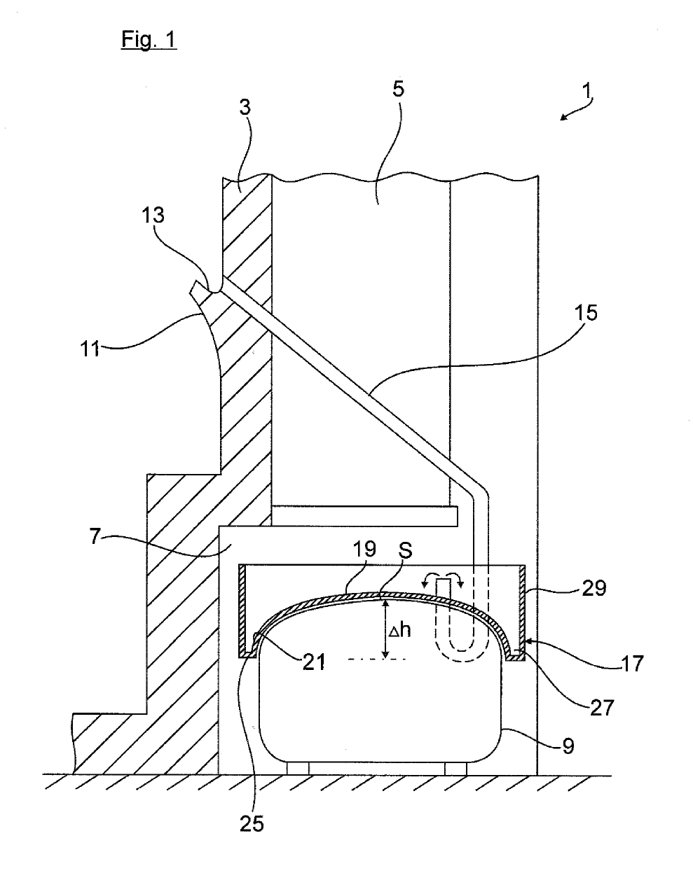

FIG. 1 shows a schematic partial section through a refrigeration appliance;

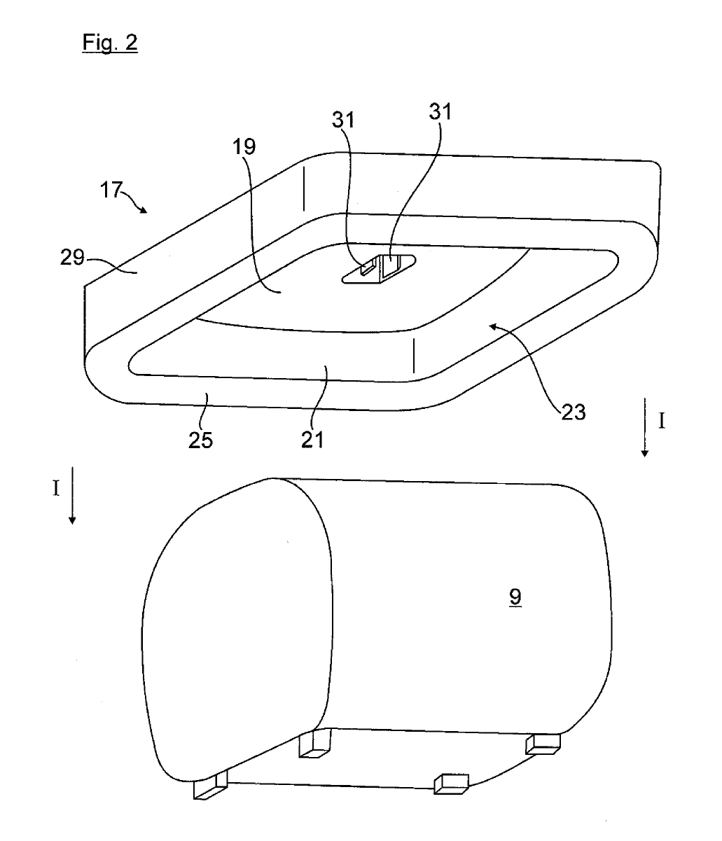

FIG. 2 shows an exploded view of the compressor with assigned condensation collection container; and

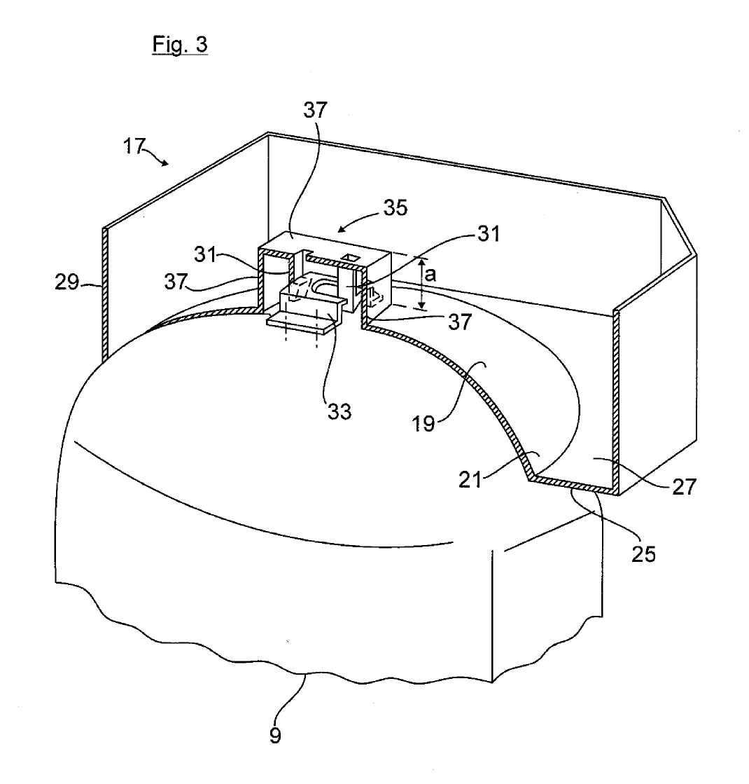

FIG. 3 shows a partial section through the condensation collection container disposed on the compressor.

FIG. 1 shows a schematic partial view of the rear region of an appliance housing 1 of a refrigeration appliance. The housing 1 features a condenser 5 (simply shown in outline) on the rear wall 3 in the known manner. It is part of a refrigerant circuit and serves to cool the refrigeration compartment of the refrigeration appliance. Near the bottom the rear wall 3 has a cutout 7, in which a compressor 9 of the refrigerant circuit is disposed.

During the cooling operation water condenses and freezes on the inner surface of the housing rear wall 3. In order to collect the condensed water in a defrost process a wall projection 11 is molded on the housing inner wall 3 on the inside of the housing, forming a defrost water channel 13. The defrost water channel 13 is connected by way of a condensation line 15 for flow purposes to a condensation collection container 17, which rests on the top of the compressor 9 outside the housing interior.

In the present instance the container 17 is embodied as a plastic tray, which can be produced using a plastic injection molding procedure. The condensation collected in the defrost water channel 13 is conducted during the defrost process by way of the condensation line 15 into the condensation tray and evaporates there using the energy released from the compressor 9.

As shown in the figures, the condensation tray is embodied as open at the top. The condensation tray 17 is also configured with a hood-type base 19, which transitions at the edge into a side wall 21 running round it in the manner of a frame. The side wall 21 of the container base 19 of the condensation tray 17 therefore delimits a domed hollow space 23 that is open at the bottom, as shown in FIG. 2. The base 19 and side wall 21 of the condensation tray 17 cover the upper region of the compressor 9 in the manner of a cap.

As shown in the cross-sectional view in FIG. 1, the condensation tray 17 projects beyond the compressor 9 in a horizontal lateral direction with a horizontal edge web 25 running round it, which is disposed with a height difference Δh below a compressor top point S. The edge web 25 directly adjoins the side wall 21 and is disposed roughly at the height of a compressor side wall. The horizontal edge web 25 also forms a channel base of a collection channel 27 of the condensation tray 17 running round the sides of the compressor 9. Outside at the side the edge web 25 transitions into a vertically elevated outer wall 29 of the condensation tray 17.

The base 19 of the condensation tray 17 together with its side wall 21 is tailored with a form fit to the contour of the upper compressor region. This allows a large surface contact region to be achieved between the condensation tray 17 and the upper compressor region, with the result that the energy released from the compressor 9 can be introduced almost without loss into the condensation tray 17.

FIG. 2 shows the condensation tray 17 on its own. According to this the bottom edge web 25 runs at the same height in the shape of a rectangle around the domed hollow space 23, which is delimited by the base and side walls 19, 21 of the condensation tray 17 and is curved in a concave manner in the direction of the compressor.

The condensation tray 17 is mounted on the upper region of the compressor 9 in the vertical assembly direction I shown. The shape of the base of the condensation tray 17 means that the tray rests on the compressor 9 with essentially no clearance in the horizontal plane.

In order to prevent inadvertent detachment of the condensation tray 17 upward in a vertical direction, additional elastically flexible latching elements 31 are provided. In the assembled state according to FIG. 3 these engage below a holding bracket 33 fastened to the top of the compressor 9. The latching elements 31 are configured within a fastening well 35 according to FIGS. 2 and 3. The fastening well 35 opens centrally at the top point of the concave base wall 19 into the domed hollow space 23, as shown in FIG. 2.

In the assembled state in FIG. 3 the box-shaped fastening well 35 encloses the holding bracket 33 of the compressor 9 in the manner of a hood, without adversely affecting the form-fit contact between the condensation tray 17 and the upper face of the compressor. As also shown in FIG. 3 the fastening well 35 with its four side walls (three of which are shown in the partial section in FIG. 3) delimits the holding bracket 33. The latching elements 31 are molded on a well top wall 37, which is at a distance a from the compressor 9.

Demolding openings are provided in the fastening well top wall 37 according to FIG. 3, by means of which the injection molding tools can be removed from the plastic tray 17 in a demolding direction after the injection molding process has been completed. During customer service visits the demolding openings in the top wall 37 can be used for tool access, to disengage the latching elements 31 from the holding bracket 33.

### LIST OF REFERENCE CHARACTERS

1 Housing
3 Rear wall
5 Condenser
7 Cutout
9 Compressor
11 Wall projection
13 Defrost water channel
17 Condensation collection container
19 Base wall
21 Side wall
23 Domed hollow space
25 Edge web
27 Collection channel
29 Outer wall of condensation collection container 17
31 Fastening element
33 Holding part
35 Fastening well
37 Well side walls
39 Well top wall
Δh Height difference
S Top point
a Distance

1-15. (canceled)

16. A refrigeration appliance, comprising:
a refrigerant circuit;
a compressor connected in the refrigerant circuit; and
a condensation collection container collecting condensation formed during operation of the refrigeration appliance, said condensation collection container having a base resting on an upper face of the compressor and having a side wall which projects towards the compressor and embraces a periphery of the compressor in the manner of a frame.

17. The refrigeration appliance of claim 16, constructed in the form of a household refrigeration appliance.

18. The refrigeration appliance of claim 16, wherein the base has a base wall which connects to the side wall, at least one member selected from the group consisting of the side wall and the base wall having a contour which substantially follows a contour of an upper compressor region with a form fit.

19. The refrigeration appliance of claim 16, wherein the condensation collection container is constructed for mounting on the compressor in a vertical assembly direction.

20. The refrigeration appliance of claim 18, wherein the condensation collection container is connected in a latched manner with a holding part of the compressor without any need for a tool.

21. The refrigeration appliance of claim 19, wherein the holding part is disposed on the upper face of the compressor.

22. The refrigeration appliance of claim 19, wherein the holding part is disposed on the upper face of the compressor in proximity to a top point of the upper face of the compressor.

23. The refrigeration appliance of claim 16, wherein the condensation collection container has a fastening well for engagement of a holding part of the compressor.

24. The refrigeration appliance of claim 22, further comprising at least one fastening element arranged within the fastening well of the condensation collection container for engagement with the holding part.

25. The refrigeration appliance of claim 23, wherein fastening element is a latching element.

26. The refrigeration appliance of claim 22, wherein the fastening well has side walls, which enclose the holding part in the manner of a frame.

27. The refrigeration appliance of claim 23, wherein the fastening well has a well top wall spaced at a distance from the compressor and supporting the fastening element.

28. The refrigeration appliance of claim 23, wherein the fastening element holds the condensation collection container under tension on the upper face of the compressor when engaged with the holding part.

29. The refrigeration appliance of claim 23, wherein the fastening element holds the condensation collection container under tension on the upper face of the compressor when engaged with the holding part on a top point of the upper face of the compressor.

30. The refrigeration appliance of claim 26, wherein the well top wall has at least one tool access opening for releasing the fastening element.

31. The refrigeration appliance of claim 16, wherein the condensation collection container has a collection channel all round it, which runs laterally around the compressor and is closed in the manner of a frame.

32. The refrigeration appliance of claim 30, wherein the collection channel is delimited by the side wall running round it and a container outer wall, said side wall and the container outer wall being connected to one another by an edge web.

33. The refrigeration appliance of claim 30, wherein the collection channel of the condensation collection container is disposed vertically below a compressor top point by a height difference.

34. A condensation collection container for collecting condensation formed during operation of a refrigeration appliance, said condensation collection container comprising a base resting on an upper face of a compressor of the refrigeration appliance and having a side wall which projects towards the compressor and embraces a periphery of the compressor in the form of a frame.

35. A method for assembling a refrigeration appliance having a compressor connected in a refrigerant circuit, and a condensation collection container collecting condensation formed during operation of the refrigeration appliance, said method comprising connecting the condensation collection container to the compressor in a vertical assembly direction.
